(19) United States
(12) Patent Application Publication
(10) Pub. No.: US 2015/0222459 A1
(43) Pub. Date: Aug. 6, 2015

(54) METHODS AND DEVICES FOR DYNAMIC FILTER CONFIGURATION IN THE PRESENCE OF ADJACENT CHANNEL INTERFERENCE (ACI)

(71) Applicant: QUALCOMM Incorporated, San Diego, CA (US)

(72) Inventors: Hassan Rafique, Farnborough (GB); Mukund Agarwal, Farnborough (GB); Divaydeep Sikri, Farnborough (GB)

(73) Assignee: QUALCOMM Incorporated, San Diego, CA (US)

(21) Appl. No.: 14/172,579

(22) Filed: Feb. 4, 2014

(51) Int. Cl. H04L 25/03; H04B 17/00; H04L 25/08

(52) U.S. Cl. CPC H04L 25/03828; H04L 25/08; H04B 17/005

(57) ABSTRACT

Apparatus and methods enable rejection of adjacent channel interference (ACI) in a way that mitigates reductions in performance, such as increased bit error rates, which might otherwise occur with conventional filtering algorithms used to combat ACI. For example, a filter or a filter stage may be shifted in frequency by an amount that corresponds to a measured power of the ACI. In some examples, the amount to shift the filter may correspond to a carrier to interference (C/I) ratio, which itself is based in part on the ACI. In some examples, the amount to shift the filter may further depend on the noise power in the wireless channel, since a lesser shift of the filter frequency may be beneficial in noisy environments.

### TECHNICAL FIELD

The following relates generally to wireless communication, and more specifically to methods and devices for dynamic filter configuration in the presence of adjacent channel interference (ACI) in a wireless communication network.

### BACKGROUND

Wireless communication systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power).

In any wireless communication network, adjacent channel interference (ACI) can degrade the signal quality of a received signal. ACI occurs when a mobile device is assigned and is utilizing a particular frequency channel (which may be denoted as channel n), and one or more other devices are transmitting interfering signals in an adjacent channel (e.g., channel n+1 and/or channel n−1), or in nearby channels (e.g., channels n±2, n±3, etc.). In general, to reduce the effects of ACI, prior art mobile devices are known to employ bandpass filters in their receive chain to filter out the interfering signals while passing the desired signals.

As the demand for mobile broadband access continues to increase, research and development continue to advance wireless technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosure provide apparatus and methods that enable rejection of adjacent channel interference (ACI) in a way that mitigates reductions in performance, such as increased bit error rates, which might otherwise occur with conventional filtering algorithms used to combat ACI. For example, a filter or a filter stage may be shifted in frequency by an amount that corresponds to a measured power of the ACI. In some examples, the amount to shift the filter may correspond to a carrier to interference (C/I) ratio, which itself is based in part on the ACI. In some examples, the amount to shift the filter may further depend on the noise power in the wireless channel, since a lesser shift of the filter frequency may be beneficial in noisy environments.

For example, in one aspect, the disclosure provides a method of wireless communication, including dynamically configuring a pass band of a filter in accordance with one or more characteristics of ACI and one or more characteristics of noise.

Another aspect of the disclosure provides a wireless communication device, including a processing circuit, a communication interface communicatively coupled to the processing circuit, and a memory communicatively coupled to the processing circuit. Here, the processing circuit is configured to dynamically configure a pass band of a filter of the communication interface in accordance with one or more characteristics of ACI and one or more characteristics of noise.

Another aspect of the disclosure provides a wireless communication device, including means for receiving a downlink carrier, and means for dynamically configuring a pass band of a filter for filtering the downlink carrier, in accordance with one or more characteristics of ACI and one or more characteristics of noise.

Another aspect of the disclosure provides a computer-readable storage medium including instructions for causing a computer to dynamically configure a pass band of a filter in accordance with one or more characteristics of ACI and one or more characteristics of noise.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### DRAWINGS

FIG. 1 is a schematic diagram illustrating an access network for wireless communication according to one example.

FIG. 2 is a block diagram illustrating an example of a network environment in which one or more aspects of the present disclosure may find application.

FIG. 3 is a series of charts illustrating a frequency response of a filter for rejecting adjacent channel interference (ACI) in accordance with one example.

FIG. 4 is a chart illustrating an example of data that may be gathered to empirically determine an optimal filter shift for rejecting ACI in accordance with one example.

FIG. 5 is a simple illustration of a lookup table for determining a filter shift to utilize in accordance with a determined noise power and carrier to interference (C/I) ratio in accordance with one example.

FIG. 6 is a block diagram illustrating select components of a user equipment according to at least one example.

FIG. 7 is a flow diagram illustrating an example of a method operational on a UE for dynamically altering a filter configuration in the presence of ACI according to some aspects of the disclosure.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the discussions are described below for 3rd Generation Partnership Project (3GPP) protocols and systems, and related terminology may be found in much of the following description. However, those of ordinary skill in the art will recognize that one or more aspects of the present disclosure may be employed and included in one or more other wireless communication protocols and systems.

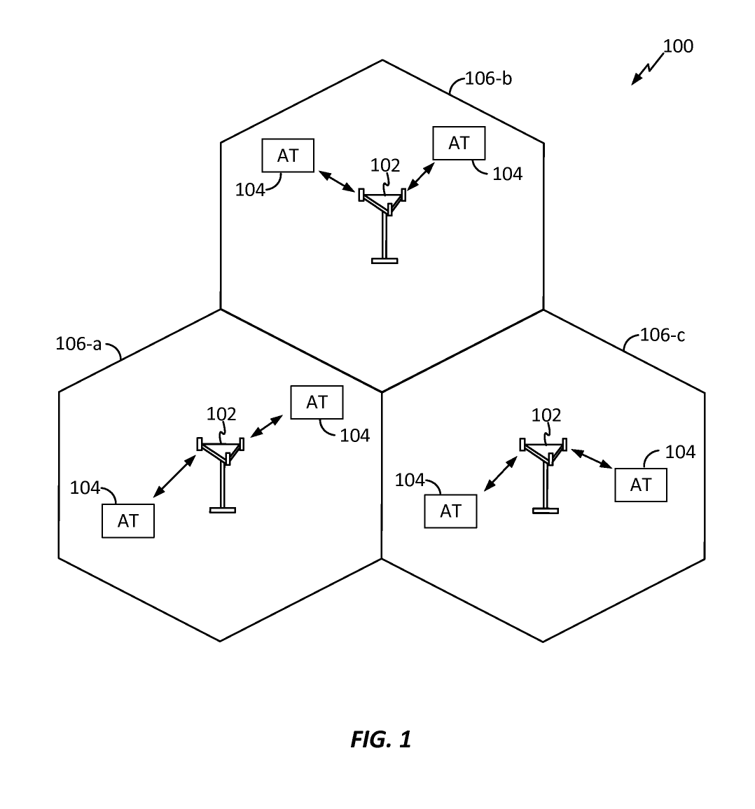

FIG. 1 is a block diagram of a network environment in which one or more aspects of the present disclosure may find application. The wireless communications system 100 includes base stations 102 adapted to communicate wirelessly with one or more user equipment (UE) 104. The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

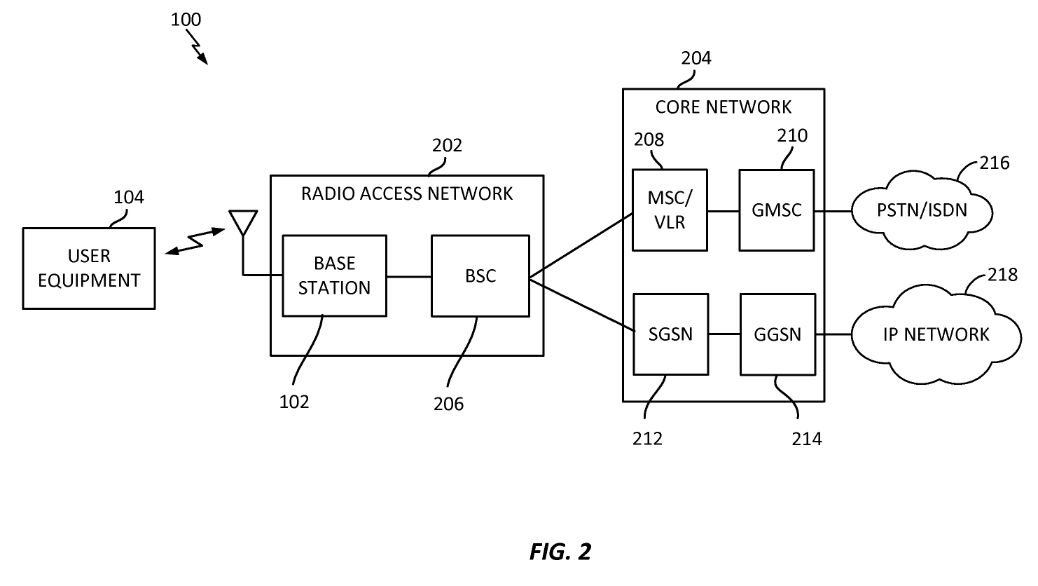

The base stations 102 can wirelessly communicate with the UEs 104 via a base station antenna. The base stations 102 may each be implemented generally as a device adapted to facilitate wireless connectivity (for one or more UEs 104) to the wireless communications system 100. The base stations 102 are configured to communicate with the UEs 104 under the control of a base station controller (see FIG. 2) via multiple carriers. Each of the base station 102 sites can provide communication coverage for a respective geographic area. The coverage area 106 for each base station 102 here is identified as cells 106-a, 106-b, or 106-c. The coverage area 106 for a base station 102 may be divided into sectors (not shown, but making up only a portion of the coverage area). The system 100 may include base stations 102 of different types (e.g., macro, micro, and/or pico base stations).

One or more UEs 104 may be dispersed throughout the coverage areas 106. Each UE 104 may communicate with one or more base stations 102. A UE 104 may generally include one or more devices that communicate with one or more other devices through wireless signals. Such a UE 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. A UE 104 may include a mobile terminal and/or an at least substantially fixed terminal. Examples of a UE 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, and/or other communication/computing device which communicates, at least partially, through a wireless or cellular network.

Turning to FIG. 2, a block diagram illustrating select components of the wireless communication system 100 is depicted according to at least one example. As illustrated, the base stations 102 are included as at least a part of a radio access network (RAN) 202. The radio access network (RAN) 202 is generally adapted to manage traffic and signaling between one or more UEs 104 and one or more other network entities, such as network entities included in a core network 204. The radio access network 202 may, according to various implementations, be referred to by those skill in the art as a base station subsystem (BSS), an access network, a GSM Edge Radio Access Network (GERAN), etc.

In addition to one or more base stations 102, the radio access network 202 can include a base station controller (BSC) 206, which may also be referred to by those of skill in the art as a radio network controller (RNC). The base station controller 206 is generally responsible for the establishment, release, and maintenance of wireless connections within one or more coverage areas associated with the one or more base stations 102 which are connected to the base station controller 206. The base station controller 206 can be communicatively coupled to one or more nodes or entities of the core network 204.

The core network 204 is a portion of the wireless communications system 100 that provides various services to UE 104 that are connected via the radio access network 202. The core network 204 may include a circuit-switched (CS) domain and a packet-switched (PS) domain. Some examples of circuit-switched entities include a mobile switching center (MSC) and visitor location register (VLR), identified as MSC/VLR 208, as well as a Gateway MSC (GMSC) 210. Some examples of packet-switched elements include a Serving GPRS Support Node (SGSN) 212 and a Gateway GPRS Support Node (GGSN) 214. Other network entities may be included, such as an EIR, HLR, VLR and AuC, some or all of which may be shared by both the circuit-switched and packet-switched domains. A UE 104 can obtain access to a public switched telephone network (PSTN) 216 via the circuit-switched domain, and to an IP network 218 via the packet-switched domain.

In any wireless communication network, including but not limited to the GSM system 100, adjacent channel interference (ACI) can degrade the signal quality of a received signal. In some scenarios, the strength of the ACI can sometimes overwhelm the carrier signal. ACI occurs when a mobile device such as the UE 104 is assigned and is utilizing a particular frequency channel (which may be denoted as channel n), and one or more other devices are transmitting interfering signals in an adjacent channel (e.g., channel n+1 and/or channel n−1), or in nearby channels (e.g., channels n±2, n±3, etc.). In general, a channel may refer to any path for transmitting electrical signals, corresponding to a frequency (e.g., a predetermined frequency) or a range of frequencies. Further, adjacent channels may be channels immediately beside the channel being utilized for communication, e.g., being higher in frequency or lower in frequency. In another example, adjacent channels may be separated from one another by a suitable gap in frequency, e.g., corresponding to a guard band. Again, within the scope of the present disclosure, the term “adjacent” may further refer not only to the channels immediately next to or alongside the communication channel, but may broadly, additionally include nearby channels that may be near enough to the communication channel such that interference (i.e., adjacent channel interference), in the form of data and/or voice communications in those channel(s), may affect reception of information on the desired communication channel.

In general, to reduce the effects of ACI, prior art access terminals are known to employ one or more bandpass filters in their receive chain (often referred to as a 3rd stage filter) to filter out the interfering signals while passing the desired signals within their pass band.

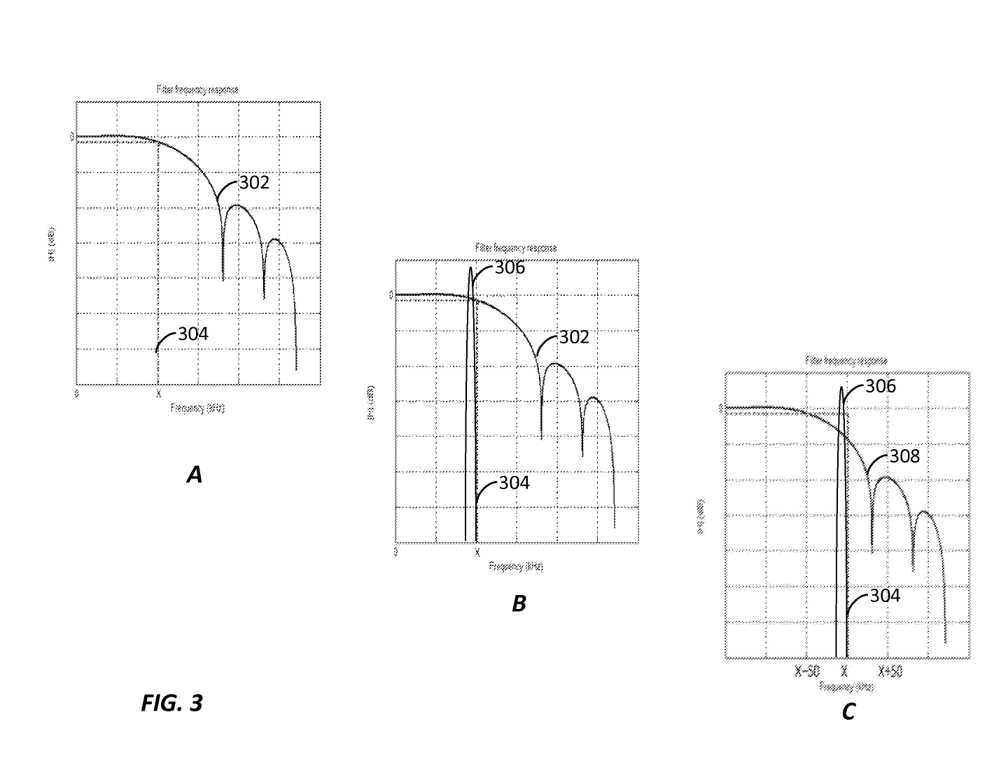

For example, FIG. 3 is a series of graphs that illustrate one conventional approach to reduce or remove the effect of ACI on the desired signal utilizing a suitably configured 3rd stage filter. As illustrated at chart A, a 3rd stage filter having the illustrated frequency response 302 may be utilized for filtering a signal to pass the portions of the signal that appear within its pass band. Here, the illustrated pass band corresponding to a cutoff frequency 304 of the 3rd stage filter lies in the range of −X to +X kHz (with only the frequencies over 0 kHz illustrated for simplicity). In chart B, adjacent channel interference (ACI) 306 appears in the range of (X-20)-X kHz. Here, a conventional access terminal may detect the presence of the ACI 306, and if such ACI is detected, the 3rd stage filter is shifted by a fixed amount to the left (to lower frequencies), e.g., by 50 kHz, so that it passes frequencies from −X-50 to X-50 kHz. Thus, the frequency response 308, seen in chart C, would substantially reject the ACI 308, while passing the desired signal. In the illustrated example, rejecting the ACI is shown by illustrating that the ACI is substantially outside of the pass band of the 3rd stage filter (i.e., beyond the 3 dB cutoff frequency of the filter). However, within the scope of the disclosure, to reject the ACI may be broadly interpreted to mean substantially reducing the effect of the ACI on the desired signal.

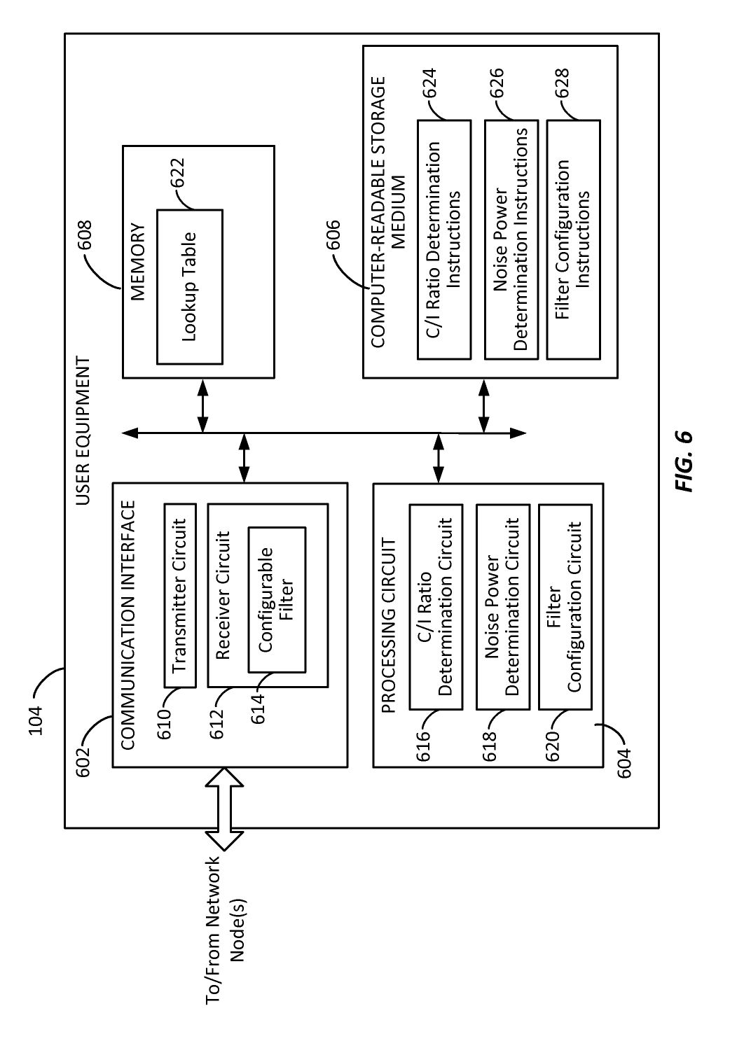

However, according to an aspect of the present disclosure as described more fully below, this simple shift of the 3rd stage filter by a fixed amount (e.g., 50 kHz) in the presence of ACI, can be less than optimal under certain ACI values, and/or under high noise power conditions. Therefore, according to some aspects of the disclosure, a simple fixed shift in the presence of ACI may no longer be implemented. Rather, a filter in the receiver chain at the UE 104 (e.g., the configurable filter 614 shown in FIG. 6 and described below) may dynamically determine an amount of shift to use, in accordance with the strength of the detected ACI and the power of the noise present. For example, a lookup table may be used to select a best shift to utilize for the filter according to a measured parameter corresponding to the ACI (e.g., a carrier to interference ratio C/I), and/or a measured noise power.

For various purposes, existing UEs utilized in the field are already configured to determine a carrier-to-interference ratio (C/I). Here, the C/I ratio generally corresponds to a measured power of a desired carrier, divided by a measured power of an interfering signal, such as the detected ACI. In accordance with some aspects of the present disclosure, this C/I measurement may be re-purposed, so as to be utilized as a factor in a determination of an amount to shift a filter (e.g., the 3rd stage filter) for filtering out the ACI.

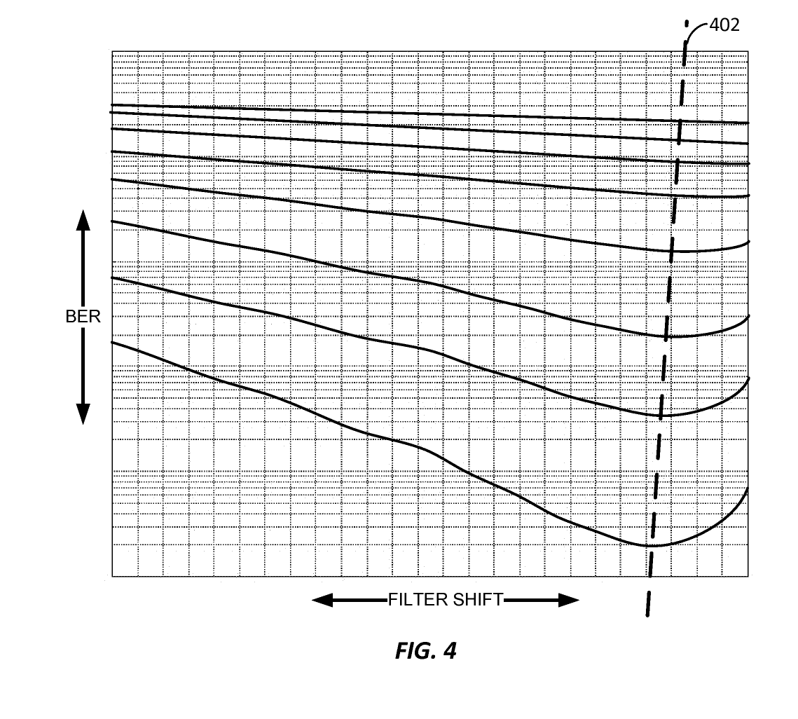

In a further aspect of the disclosure, an optimal shift to utilize for a filter (e.g., the 3rd stage filter) for filtering out the ACI may be determined empirically. For example, as illustrated in FIG. 4, data corresponding to a bit error rate (BER) may be gathered for a range of C/I values, and a range of filter shifts. Of course, the BER is merely one example of a metric of channel performance that may be utilized to gauge the performance of varying filter shifts, and in other examples, any suitable metric of channel performance may be utilized to build a dataset from which a lookup table may be generated.

In the illustrated chart, the vertical axis represents a measured BER, and the horizontal axis shows an amount of filter shift implemented in a filter (e.g., the 3rd stage filter). Here, each of the lines shows variation in the BER as the filter is shifted, with each line representing a different C/I ratio (e.g., corresponding to different ACI power). As illustrated, the shift amount increases to the right-hand side of the chart (the right is the positive direction); and the amount of shift corresponds to a shift of the filter (e.g., the 3rd stage filter) to the left (referring to FIG. 3, a shift of the filter to the left, as illustrated in chart C, corresponds to a positive shift in the chart of FIG. 4). As seen in FIG. 4, by varying the amount of filter shift under a wide range of C/I values, it may be empirically determined which amount of filter shift results in the lowest BER. In the illustrated example, the point of the lowest BER for each curve is shown by their respective intersections with the dashed line 402. However, this straight line relationship is merely provided as one example. In accordance with various aspects of the disclosure, based on implementation details of a receiver circuit in a particular UE, the optimal filter shift for each detected C/I value may not be related in this linear fashion, or in any mathematical fashion. For example, an optimal filter shift for a first detected C/I ratio may be totally unrelated to an optimal filter shift for a second detected C/I ratio. Of course, a linear relationship between respective optimal filter shifts may result as well.

In some aspects of the disclosure, in order to implement such empirically determined optimal shift values, a lookup table may be implemented at the UE 104, wherein an amount of filter shift to employ (e.g., in kHz), may be selected in accordance with a detected C/I ratio. That is, after the UE 104 utilizes suitable receiver circuitry to detect an ACI signal and a desired carrier, and to determine a C/I ratio corresponding to the ratio between the desired carrier and the ACI, the UE 104 may utilize this determined C/I ratio as an input to a function or a table to select a suitable filter shift. Thereafter, the UE 104 may shift the filter (e.g., the 3rd stage filter) by the selected amount.

In a further aspect of the disclosure, one or more other factors in addition or alternative to the strength of the ACI may be utilized to determine the optimal shift of the filter (e.g., the 3rd stage filter). For example, noise power in the channel may be utilized in the determination of the filter shift. That is, as the filter (e.g., the 3rd stage filter) is shifted to the left to avoid the ACI, this same shift may result in the filter passing lower frequencies (especially in the case where the bandwidth of the filter is unchanged). Here, if there is high noise power in the channel, more noise can affect the received signal when the filter is shifted in this manner. That is, in noisy conditions, generally the more that the filter is shifted, the more that noise may affect the desired carrier.

Therefore, in a further aspect of the present disclosure, the noise power may be an additional or alternative factor utilized by the UE 104 to determine an amount to shift the filter (e.g., the 3rd stage filter). In one example, the UE 104 may utilize a lookup table (e.g., the lookup table described above) to find a filter shift amount in accordance with the noise power, in addition or alternatively to the C/I ratio.

As in the example above describing the use of the C/I ratio, here, the amount of shift to utilize in accordance with a particular amount of detected noise power may be determined empirically. In some examples, under higher noise conditions, the optimal amount to shift the filter may be lesser; however, in lower noise conditions, the optimal amount of shift may be greater.

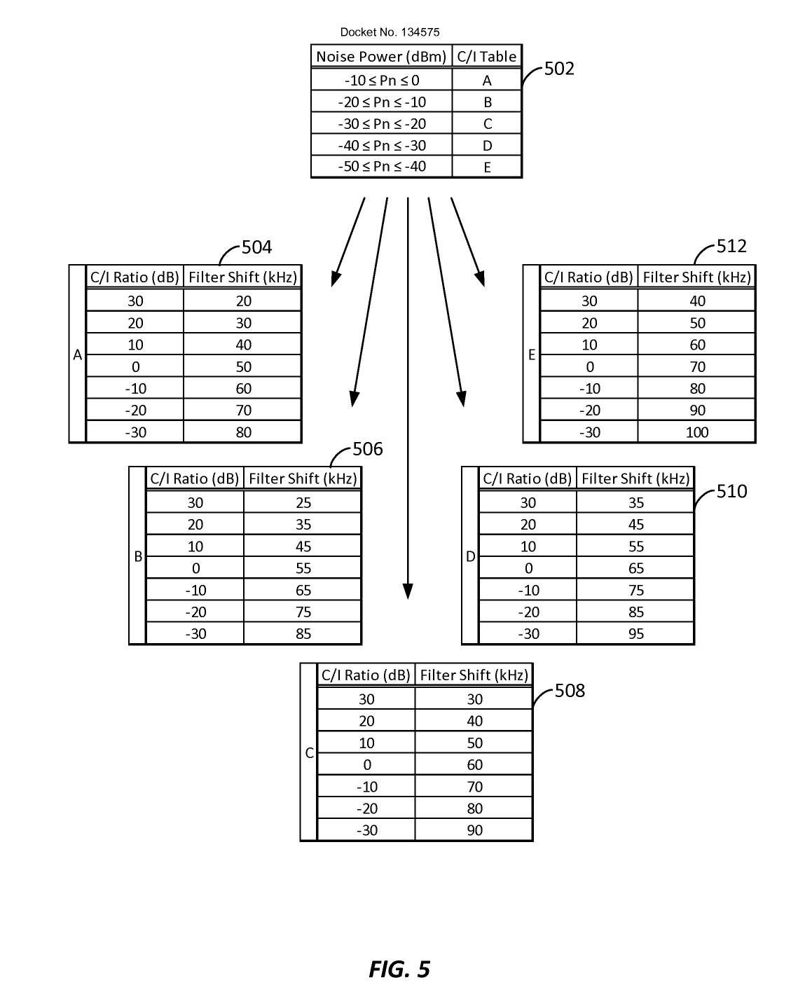

FIG. 5 is an illustration of a series of lookup tables that may be utilized in accordance with one example. In an implementation utilizing these tables, a UE 104 may determine a noise power and a C/I ratio. In accordance with the noise table 502, the UE 104 may determine which C/I lookup table (504, 506, 508, 510, or 512) to utilize. That is, the entry in the noise table 502 into which the measured noise power falls provides an indication which C/I table to utilize. Thereafter, utilizing the selected C/I lookup table, the UE 104 may determine the amount to shift the filter (e.g., the 3rd stage filter) in accordance with the measured C/I ratio.

In this illustration, five C/I tables are provided, corresponding to five ranges of noise power. Further, certain ranges of noise power, and certain C/I ratios, are provided, simply to illustrate exemplary values. Those skilled in the art will recognize that the number of C/I tables may be greater or lesser than 5 within the scope of the disclosure. Further, those skilled in the art will recognize that the values in each table, and the number of entries, and their ranges, may be varied and may take any suitable value within the scope of the disclosure.

Still further, in the illustrated example, the UE 104 is shown first to look at the noise power, and based on the noise power, to select a corresponding C/I table. In another example, the UE 104 may be configured first to look at the C/I ratio, and based on the C/I ratio, to select a corresponding noise power table. That is, the present disclosure is not limited to a particular order of variables for consideration of the filter shift.

Moreover, the present disclosure is not limited only to the use of a C/I ratio and/or to a noise power for determining the amount to shift the filter (e.g., the 3rd stage filter) to reduce or avoid ACI. In accordance with various aspects of the disclosure, any suitable channel characteristics or measurements may be made and utilized to determine the filter shift.

In a further aspect of the disclosure, one or more characteristics of the filter (e.g., the 3rd stage filter) other than its center frequency may be modified or altered for reducing or avoiding ACI. For example, the bandwidth of the filter (e.g., the 3rd stage filter) may be modified, e.g., reduced, in accordance with one or more factors such as the C/I ratio and/or the noise power, in order to reduce or avoid ACI while attempting to maintain reception of the desired channel.

FIG. 6 is a block diagram illustrating select components of a UE 104 configured for adjusting a filter in the presence of ACI in accordance with one or more aspects of the present disclosure. The UE 104 illustrated in FIG. 6 may be the same UE 104 as illustrated in FIGS. 1 and/or 2, and may be configured to implement any one or more of the filtering algorithms, features, functions, or characteristics described herein and illustrated in FIGS. 3, 4, 5, and/or 7.

As illustrated, the UE 104 may include a communication interface 602, a processing circuit 604, a computer-readable storage medium 606, and a memory 608. Here, the processing circuit 604 may be coupled to or placed in electrical communication with the communication interface 602, the computer-readable storage medium 606, and the memory 608 by way of a suitable bus or other interface. The processing circuit 604 is arranged to obtain, process and/or send data, control data access and storage, issue commands, and control other desired operations. The processing circuit 604 may include circuitry configured to implement desired programming provided by appropriate media in at least one example. For example, the processing circuit 604 may be implemented as one or more processors, one or more controllers, and/or other structure configured to execute executable programming. Examples of the processing circuit 604 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 604 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 604 are for illustration and other suitable configurations within the scope of the present disclosure are also contemplated.

The processing circuit 604 is adapted for processing, including the execution of programming, which may be stored on the computer-readable storage medium 606. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 604 may include a C/I ratio determination circuit 616. The C/I ratio determination circuit 616 may include circuitry and/or programming (e.g., programming stored on the storage medium 606) adapted to, among other things, detect the presence of ACI; determine the power, energy, or other suitable measure of the strength of the detected ACI; detect a desired signal; determine the power, energy, or other suitable measure of the strength of the detected desired signal; and determine the C/I ratio corresponding to the strength of the detected ACI and the strength of the desired signal.

In some instances, the processing circuit 604 may include a noise power determination circuit 618. The noise power determination circuit 618 may include circuitry and/or programming (e.g., programming stored on the storage medium 606) adapted to, among other things, determine the power, energy, or other suitable measure of the amount of noise on the communication channel(s).

In some instances, the processing circuit 604 may include a filter configuration circuit 620. The filter configuration circuit 620 may include circuitry and/or programming (e.g., programming stored on the storage medium 606) adapted to, among other things, control one or more characteristics or parameters of the configurable filter 614. For example, the filter configuration circuit 620 may be enabled to retrieve information such as the C/I ratio, determined by the C/I ratio determination circuit 616, and the noise power, determined by the noise power determination circuit 618, and access a lookup table 622 stored in memory 608 to find a corresponding filter configuration value. For example, the filter configuration value may correspond to an amount to shift the center frequency of the configurable filter 614. In other examples, the filter configuration value may correspond to a change in the bandwidth of the configurable filter 614, or to any other suitable change of the upper and/or lower cutoff frequencies of the configurable filter 614.

The storage medium 606 may represent one or more computer-readable, machine-readable, and/or processor-readable devices for storing programming, such as processor executable code or instructions (e.g., software, firmware), electronic data, databases, or other digital information. The storage medium 606 may also be used for storing data that is manipulated by the processing circuit 604 when executing programming. The storage medium 606 may be any available media that can be accessed by a general purpose or special purpose processor, including portable or fixed storage devices, optical storage devices, and various other mediums capable of storing, containing or carrying programming. By way of example and not limitation, the storage medium 606 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The computer-readable storage medium 606 may be coupled to the processing circuit 604 such that the processing circuit 604 can read information from, and write information to, the storage medium 606. That is, the storage medium 606 can be coupled to the processing circuit 604 so that the storage medium 606 is at least accessible by the processing circuit 604, including examples where the storage medium 606 is integral to the processing circuit 604 and/or examples where the storage medium 606 is separate from the processing circuit 604 (e.g., resident in the UE 104, external to the UE 104, distributed across multiple entities, etc.).

Programming stored by the storage medium 606, when executed by the processing circuit 604, causes the processing circuit 604 to perform one or more of the various functions and/or process steps described herein. For example, the storage medium 606 may include C/I ratio determination operations (or instructions) 624, noise power determination operations (or instructions) 626, and filter configuration instructions 628. The C/I ratio determination operations 624, the noise power determination operations 626, and the filter configuration operations 628 can be implemented by the processing circuit 604 in, for example, the C/I ratio determination circuit 616, the noise power determination circuit 618, and/or the filter configuration circuit 620 to determine the C/I ratio, to determine the noise power, and/or to configure the configurable filter 614. Thus, according to one or more aspects of the present disclosure, the processing circuit 604 may be adapted to perform (in conjunction with the storage medium 606) any or all of the processes, functions, steps and/or routines for any or all of the UEs described herein (e.g., UE 104). As used herein, the term “adapted” in relation to the processing circuit 604 may refer to the processing circuit 604 being one or more of configured, employed, implemented, or programmed to perform a particular process, function, step and/or routine according to various features described herein.

The communication interface 602 may include one or more transmitter circuit(s) 610 and one or more receiver circuit(s) 612. The communication interface 602 is configured to facilitate wireless communications of the communications device 400. For example, the communication interface 602 may include circuitry and/or programming adapted to facilitate the communication of information bi-directionally with respect to one or more network nodes. The communication interface 602 may be coupled to one or more antennas (not shown), and includes wireless transceiver circuitry, including at least one transmitter circuit 610 (e.g., one or more transmitter chains) and/or at least one receiver circuit 612 (e.g., one or more receiver chains). By way of example and not limitation, the at least one receiver circuit 612 may include circuitry, devices and/or programming adapted to receive, demodulate and process wireless transmissions to recover information included in the wireless transmissions. In an aspect of the disclosure, the receiver circuit 612 may include a configurable filter circuit 614 that, in various examples, may include a bandpass (or low pass or high pass filter as needed) that may be capable of shifting its center frequency, altering its bandwidth, or otherwise modifying an upper and/or lower cutoff frequency under configuration or control of the processing circuit 604.

The memory 608 may be any suitable medium for storing information, including storage space addressable by the processing circuit 604, and in some examples, may further include associated circuitry for reading, writing, addressing, and refreshing data in any memory cells. In an aspect of the disclosure, the memory 608 may store one or more lookup table(s) 622 configured for associating a filter configuration parameter with one or more determined input parameters. For example, a filter configuration parameter may correspond to a shift in the frequency of a configurable filter 614 (e.g., the 3rd stage filter); to a change in a bandwidth of the configurable filter 614; and/or to any suitable shift in an upper and/or a lower cutoff frequency of the configurable filter 614. Further, for example, the determined input parameters may include a determined C/I ratio and/or a determined noise power. In one example, the lookup table 622 may be similar to the tables illustrated in FIG. 5 and described above.

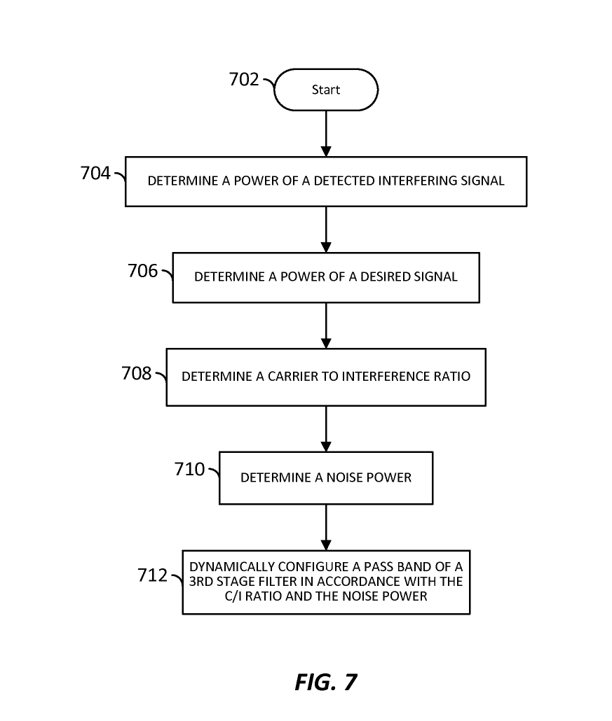

FIG. 7 is a flow chart illustrating an exemplary process 700 for dynamically configuring a filter (e.g., a 3rd stage filter) in the presence of ACI in accordance with some aspects of the present disclosure. In various examples, the process 700 may be implemented by the UE 104 illustrated in FIGS. 1, 2, and 6. In other examples, the process 700 may be implemented by a processing circuit such as the processing circuit 604, or by any other suitable means for carrying out the described functions.

At block 702, the process may start, wherein the UE 104 may establish a wireless communication link over a suitable wireless communication network (e.g., the network 100 illustrated in FIGS. 1 and 2). At block 704, the UE 104 may utilize a receiver circuit 612 to determine a power of a detected interfering signal. Here, the interfering signal may be in an adjacent channel (e.g., the immediately next channel, or in a nearby channel that may affect communication in the desired channel). This interfering signal may be ACI. At block 706, the UE 104 may utilize the receiver circuit 612 to determine a power of a desired signal, which may correspond to the wireless communication link described above in relation to block 702.

Thus, at block 708, the UE 104 may utilize the C/I ratio determination circuit 616 to determine the C/I ratio, in accordance with the power of the detected interfering signal from block 704 and the power of the desired signal from block 706.

At block 710, the UE 104 may utilize the noise power determination circuit 618 to determine a noise power corresponding to the amount of noise on the communication channel(s). Finally, at block 712 the UE 104 may dynamically configure a pass band of configurable filter 614 (e.g., the 3rd stage filter) in accordance with the C/I ratio and/or the noise power. For example, the UE 104 may utilize the lookup table 622, which may be populated with data determined empirically to provide an optimal amount of filter alteration or shift in accordance with the used input parameters (e.g., the C/I ratio and/or the noise power).

In one configuration, the apparatus 104 for wireless communication includes means for receiving a downlink carrier, and means for dynamically configuring a pass band of a filter for filtering the downlink carrier. In one aspect, the aforementioned means may be the configurable filter 614 of the communication interface 602, and/or the processing circuit(s) 604 configured to perform the functions recited by the aforementioned means. In another aspect, the aforementioned means may be a circuit or any apparatus configured to perform the functions recited by the aforementioned means.

Of course, in the above examples, the circuitry included in the processing circuit 604 is merely provided as an example, and other means for carrying out the described functions may be included within various aspects of the present disclosure, including but not limited to the instructions stored in the computer-readable storage medium 606, or any other suitable apparatus or means described in any one of the FIG. 1, 2, or 6, and utilizing, for example, the processes and/or algorithms described herein in relation to FIGS. 3, 4, and/or 7.

While the above discussed aspects, arrangements, and embodiments are discussed with specific details and particularity, one or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added or not utilized without departing from the invention. The apparatus, devices and/or components illustrated in FIGS. 1, 2, and/or 6 may be configured to perform or employ one or more of the methods, features, parameters, or steps described in FIGS. 3, 4, 5, and/or 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A method of wireless communication, comprising:
dynamically configuring a pass band of a filter in accordance with one or more characteristics of adjacent channel interference (ACI) and one or more characteristics of noise.

2. The method of claim 1, wherein the dynamically configuring the pass band of the filter comprises shifting the filter to reject the ACI.

3. The method of claim 2, wherein the dynamically configuring the pass band of the filter further comprises altering a bandwidth of the filter.

4. The method of claim 2, further comprising:
determining a strength of detected ACI; and
utilizing an ACI lookup table to determine the amount to shift the filter in accordance with the determined ACI strength.

5. The method of claim 4, further comprising:
determining a strength of a desired signal; and
determining a carrier to interference (C/I) ratio corresponding to the strength of the desired signal and the strength of the detected ACI,
wherein the ACI lookup table relates the C/I ratio to the amount to shift the filter.

6. The method of claim 4, further comprising:
determining a noise power; and
utilizing a noise lookup table further to determine the amount to shift the filter in accordance with the determined noise power.

7. A wireless communication device, comprising:
a processing circuit;
a communication interface communicatively coupled to the processing circuit; and
a memory communicatively coupled to the processing circuit,
wherein the processing circuit is configured to dynamically configure a pass band of a filter of the communication interface in accordance with one or more characteristics of adjacent channel interference (ACI) and one or more characteristics of noise.

8. The wireless communication device of claim 7, wherein the dynamically configuring the pass band of the filter comprises shifting the filter to reject the ACI.

9. The wireless communication device of claim 8, wherein the dynamically configuring the pass band of the filter further comprises altering a bandwidth of the filter.

10. The wireless communication device of claim 8, further comprising:
determining a strength of detected ACI; and
utilizing an ACI lookup table stored in the memory to determine the amount to shift the filter in accordance with the determined ACI strength.

11. The wireless communication device of claim 10, further comprising:
determining a strength of a desired signal; and
determining a carrier to interference (C/I) ratio corresponding to the strength of the desired signal and the strength of the detected ACI,
wherein the ACI lookup table relates the C/I ratio to the amount to shift the filter.

12. The wireless communication device of claim 10, further comprising:
determining a noise power; and
utilizing a noise lookup table stored in the memory further to determine the amount to shift the filter in accordance with the determined noise power.

13. A wireless communication device, comprising:
means for receiving a downlink carrier; and
means for dynamically configuring a pass band of a filter for filtering the downlink carrier, in accordance with one or more characteristics of adjacent channel interference (ACI) and one or more characteristics of noise.

14. The wireless communication device of claim 13, wherein the means for dynamically configuring the pass band of the filter comprises means for shifting the filter to reject the ACI.

15. The wireless communication device of claim 14, wherein the means for dynamically configuring the pass band of the filter further comprises means for altering a bandwidth of the filter.

16. The wireless communication device of claim 14, further comprising:
means for determining a strength of detected ACI; and
means for utilizing an ACI lookup table to determine the amount to shift the filter in accordance with the determined ACI strength.

17. The wireless communication device of claim 16, further comprising:
means for determining a strength of a desired signal; and
means for determining a carrier to interference (C/I) ratio corresponding to the strength of the desired signal and the strength of the detected ACI,
wherein the ACI lookup table relates the C/I ratio to the amount to shift the filter.

18. The wireless communication device of claim 16, further comprising:
means for determining a noise power; and
means for utilizing a noise lookup table further to determine the amount to shift the filter in accordance with the determined noise power.

19. A computer-readable storage medium comprising:
instructions for causing a computer to dynamically configure a pass band of a filter in accordance with one or more characteristics of adjacent channel interference (ACI) and one or more characteristics of noise.

20. The computer-readable storage medium of claim 19, wherein the instructions for causing a computer to dynamically configure the pass band of the filter comprise instructions for causing a computer to shift the filter to reject the ACI.

21. The computer-readable storage medium of claim 20, wherein the instructions for causing a computer to dynamically configure the pass band of the filter further comprise instructions for causing a computer to alter a bandwidth of the filter.

22. The computer-readable storage medium of claim 20, further comprising:
instructions for causing a computer to determine a strength of detected ACI; and
instructions for causing a computer to utilize an ACI lookup table to determine the amount to shift the filter in accordance with the determined ACI strength.

23. The computer-readable storage medium of claim 22, further comprising:
instructions for causing a computer to determine a strength of a desired signal; and
instructions for causing a computer to determine a carrier to interference (C/I) ratio corresponding to the strength of the desired signal and the strength of the detected ACI,
wherein the ACI lookup table relates the C/I ratio to the amount to shift the filter.

24. The computer-readable storage medium of claim 22, further comprising:
instructions for causing a computer to determine a noise power; and
instructions for causing a computer to utilize a noise lookup table further to determine the amount to shift the filter in accordance with the determined noise power.
